(19) United States
(12) Patent Application Publication
(10) Pub. No.: US 2022/0296936 A1
(43) Pub. Date: Sep. 22, 2022

(54) MASK FRAME AND MASK

(71) Applicant: Katsunori Suetsugu, Tokyo (JP)

(72) Inventor: Katsunori Suetsugu, Tokyo (JP)

(21) Appl. No.: 17/696,966

(22) Filed: Mar. 17, 2022

(30) Foreign Application Priority Data
Mar. 19, 2021 (JP) 2021-046136

(51) Int. Cl. A62B 9/04; A41D 13/11

(52) U.S. Cl. CPC A62B 9/04; A41D 13/1107

(57) ABSTRACT

A mask frame for use in combination with a replaceable mask main body, includes: a frame main body that covers at least a part of an end portion of the mask main body; an attachment portion that is attached to a head of a user to hold the frame main body at a specific position with respect to the head; and a cover that is disposed at a specific position with respect to the frame main body to cover at least a part of the mask main body.

### CROSS REFERENCE TO RELATED APPLICATION

This application is based upon and claims the benefit of priority from Japanese Patent Application No. 2021-046136 filed Mar. 19, 2021, the entire contents of which are incorporated herein by reference.

### BACKGROUND OF THE INVENTION

### 1. Technical Field

The present invention relates to a mask and a mask frame used as part of the mask.

### 2. Description of the Related Art

Conventionally, there has been known a mask including a mask main body formed of a nonwoven fabric and a string attached to a head of a user to hold the mask main body at a specific position with respect to the head (see, for example, JP 2020-084388 A).

However, the conventional mask has a problem that aesthetic properties are not high.

Therefore, an object of the present invention is to provide a mask and a mask frame capable of improving the aesthetic properties of the mask.

### SUMMARY OF THE INVENTION

A mask frame of the present invention is a mask frame for use in combination with a replaceable mask main body, and includes: a frame main body that covers at least a part of an end portion of the mask main body; and an attachment portion that is attached to a head of a user to hold the frame main body at a specific position with respect to the head.

With this configuration, in the mask frame of the present invention, the frame main body covers at least a part of the end portion of the mask main body, whereby at least a part of the contour of a mask, which greatly affects the aesthetic properties of the mask, can be configured by the mask frame. Therefore, in the mask frame of the present invention, the aesthetic properties of the mask can be improved by the design of the mask frame.

The mask frame of the present invention may include a cover that is disposed at a specific position with respect to the frame main body to cover at least a part of the mask main body.

With this configuration, in the mask frame of the present invention, the cover covers at least a part of the mask main body, whereby the aesthetic properties of the mask can be improved by the design of the cover.

In the mask frame of the present invention, the cover may be detachably attached to the frame main body.

With this configuration, in the mask frame of the present invention, the cover is detachably attached to the frame main body, whereby the design of the mask can be easily changed by replacing the cover.

The mask frame of the present invention may include a string fixing portion that fixes, to the attachment portion, a string that is attached to the head to hold the mask main body at a specific position with respect to the head.

With this configuration, in the mask frame of the present invention, the string is fixed to the attachment portion by the string fixing portion, whereby the possibility that the string is separated from the attachment portion and stands out can be reduced. Therefore, in the mask frame of the present invention, the aesthetic properties of the mask can be improved.

The mask frame of the present invention may include a mask main body fixing portion that fixes the mask main body to the frame main body.

With this configuration, in the mask frame of the present invention, the mask main body is fixed to the frame main body by the mask main body fixing portion, whereby the possibility that at least a part of the end portion of the mask main body protrudes from the frame main body and is exposed when the mask frame is attached to the head of the user can be reduced. Therefore, in the mask frame of the present invention, the aesthetic properties of the mask can be improved.

A mask of the present invention includes: a mask frame including a mask main body fixing portion that fixes the mask main body to the frame main body; and the mask main body.

With this configuration, in the mask of the present invention, the mask main body is fixed to the frame main body by the mask main body fixing portion, whereby the possibility that at least a part of the end portion of the mask main body protrudes from the frame main body and is exposed when the mask frame is attached to the head of the user can be reduced. Therefore, the aesthetic properties of the mask of the present invention can be improved.

The aesthetic properties of the mask can be improved by the mask frame and the mask of the present invention.

### BRIEF DESCRIPTION OF THE DRAWINGS

FIG. 1 is an example of a perspective view of a mask according to a first embodiment of the present invention in a state of being attached to a head of a user;

FIG. 2 is an exploded perspective view of the mask illustrated in FIG. 1;

FIG. 3 is an example of a top view of the mask illustrated in FIG. 1;

FIG. 4A is an example of a perspective view of a mask frame illustrated in FIG. 1 in a state of being bent at a specific location; FIG. 4B is a perspective view of the mask frame in a state of being bent at a specific location, which is an example different from the example illustrated in FIG. 4A;

FIG. 5A is an example of a perspective view of the mask frame illustrated in FIG. 1 in a state where a cover is attached; FIG. 5B is a perspective view of the mask frame in a state where the cover is attached, which is an example different from the example illustrated in FIG. 5A;

FIG. 6 is an example of an end view taken along line VI-VI in FIG. 5A;

FIG. 7A is an example of a rear view of the mask frame illustrated in FIG. 5A in a state where the cover is attached to a frame main body with a fastener; FIG. 7B is a rear view of the mask frame illustrated in FIG. 7A in a state where the cover is not attached to the frame main body;

FIG. 8 is an end view taken along line VIII-VIII in FIG. 7A;

FIG. 9A is an example of a plan view of the mask frame illustrated in FIG. 5A in a state where the cover is inserted into a groove formed in the frame main body; FIG. 9B is a front view of the mask frame illustrated in FIG. 9A;

FIG. 10 is an end view taken along line X-X in FIG. 9B;

FIG. 11A is a front view of the frame main body, which is an example different from the example illustrated in FIG. 1; FIG. 11B is a front view of the frame main body, which is an example different from the examples illustrated in FIGS. 1 and 11A; FIG. 11C is a front view of the frame main body, which is an example different from the examples illustrated in FIGS. 1, 11A, and 11B;

FIG. 12A is an example of a side cross-sectional view of the mask frame illustrated in FIG. 1 in a state where an attachment portion is contracted; FIG. 12B is a side cross-sectional view of the mask frame illustrated in FIG. 12A in a state where the attachment portion is elongated;

FIG. 13 is an end view taken along line XIII-XIII in FIG. 12B in a state where a string is fixed to the attachment portion by a clip;

FIG. 14 is an example of a side cross-sectional view of the mask frame illustrated in FIG. 1 when the attachment portion has an annular shape;

FIG. 15A is an example of a side cross-sectional view of the mask frame illustrated in FIG. 1 in a state where the attachment portion is contracted when the attachment portion has an annular shape; FIG. 15B is a side cross-sectional view of the mask frame illustrated in FIG. 15A in a state where the attachment portion is elongated;

FIG. 16A is an example of a rear view of a mask according to a second embodiment of the present invention; FIG. 16B is an example of a rear view of a mask frame illustrated in FIG. 16A;

FIG. 17A is an example of a perspective view of a mask according to a third embodiment of the present invention; FIG. 17B is an exploded perspective view of the mask illustrated in FIG. 17A;

FIG. 18 is an example of a rear view of the mask illustrated in FIG. 17A;

FIG. 19A is an example of a rear view of the mask according to the third embodiment of the present invention in a state where a mask main body is fixed to a frame main body by a clip;

FIG. 19B is a rear view of a mask frame illustrated in FIG. 19A;

FIG. 20A is an example of a rear view of the mask according to the third embodiment of the present invention in a state where the mask main body is fixed to the frame main body by a pressing member; and FIG. 20B is an end view taken along line XXb-XXb in FIG. 20A.

### DETAILED DESCRIPTION

Hereinafter, embodiments of the present invention will be described with reference to the drawings.

### First Embodiment

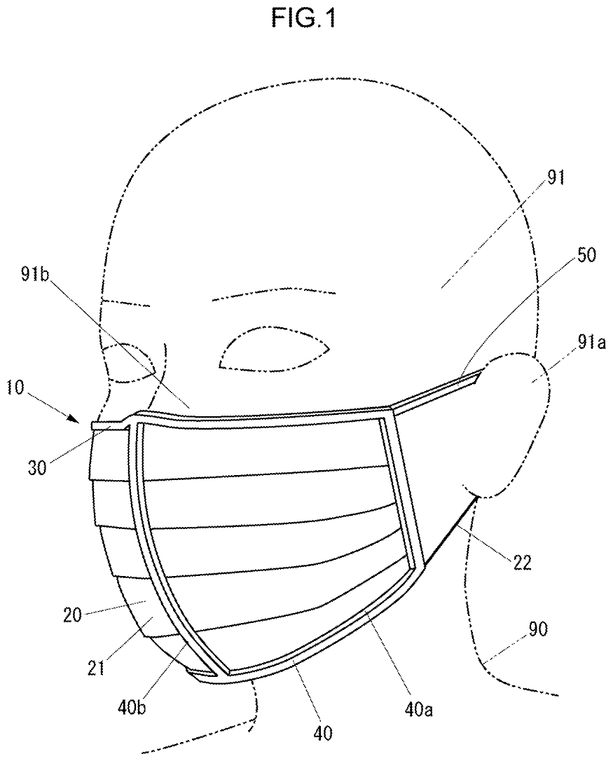

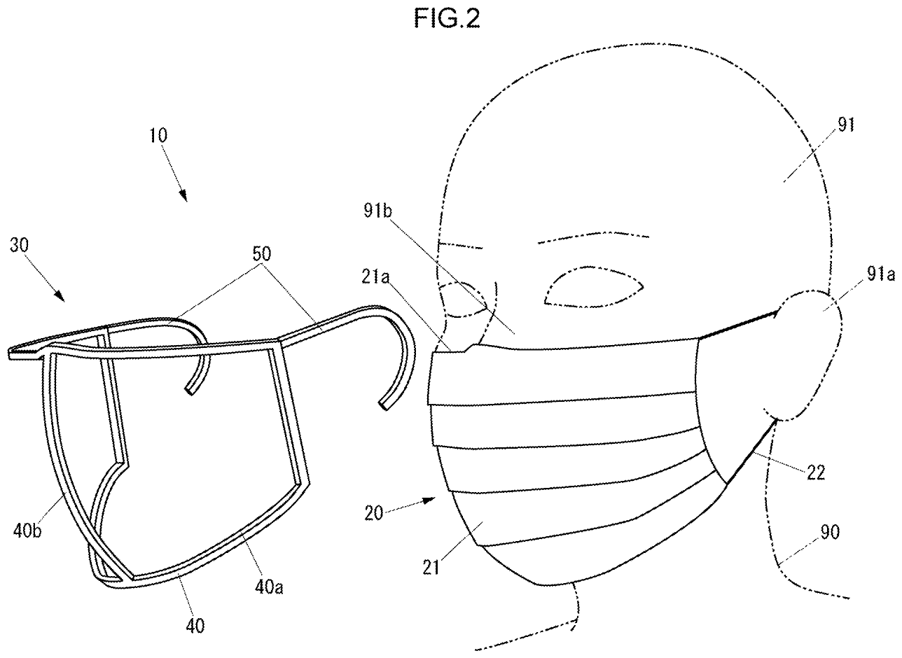

FIG. 1 is an example of a perspective view of a mask 10 according to a first embodiment of the present invention in a state of being attached to a head 91 of a user 90. FIG. 2 is an exploded perspective view of the mask 10 illustrated in FIG. 1.

As illustrated in FIGS. 1 and 2, the mask 10 includes a replaceable mask portion 20 and a mask frame 30 used in combination with the mask portion 20.

The mask portion 20 includes a mask main body 21 and a string 22 that is attached to the head 91 of the user 90 to hold the mask main body 21 at a specific position with respect to the head 91. The mask main body 21 can be formed of various materials such as a cloth other than a nonwoven fabric (such as a cotton woven fabric), a nonwoven fabric, and polyurethane. The string 22 is connected to the mask main body 21. The string 22 is attached to the head 91 of the user 90 by being hooked to an ear 91a of the user 90. As the mask portion 20, for example, a general disposable mask may be adopted.

The mask frame 30 includes a frame main body 40 that covers at least a part of an end portion 21a of the mask main body 21 of the mask portion 20, and an attachment portion 50 that is attached to the head 91 of the user 90 to hold the frame main body 40 at a specific position with respect to the head 91.

A vent hole 40a is formed in the frame main body 40. The frame main body 40 includes a vertical extending portion 40b extending in the vertical direction at the center in the horizontal direction. The frame main body 40 can be formed of various materials such as plastic having high flexibility, plastic having low flexibility, and metal.

The attachment portion 50 is attached to the head 91 of the user 90 by being hooked to the ear 91a of the user 90. The attachment portion 50 can be formed of various materials such as plastic having high flexibility, plastic having low flexibility, and metal. In particular, a portion which is a part of the attachment portion 50 and comes into contact with the ear 91a of the user 90 may be formed of a soft material.

The mask frame 30 may be formed in a general-purpose shape and size corresponding to the average shape and size of the heads of a large number of users, or may be formed in a shape and size corresponding to the shape and size of the head 91 of the individual user 90.

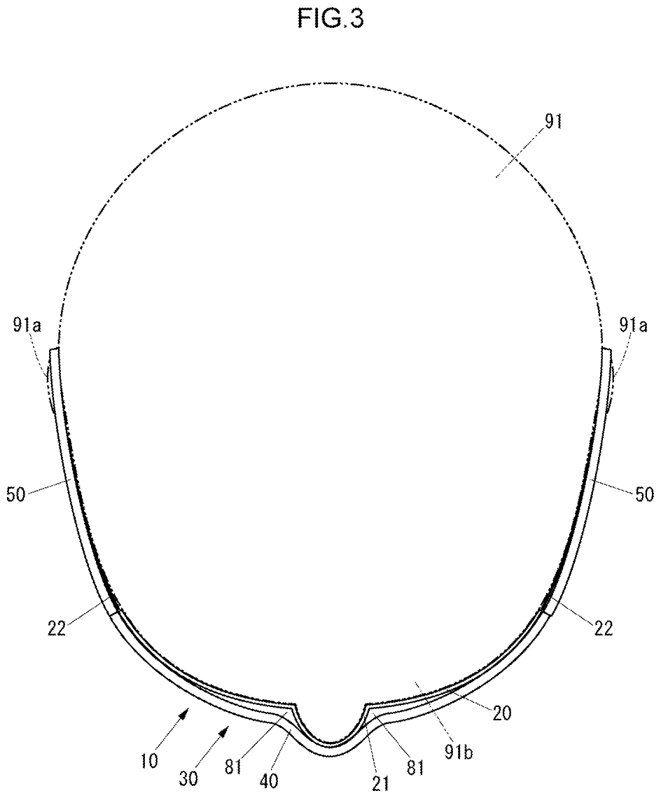

When the mask 10 includes a filler that fills a gap generated between the mask portion 20 and the mask frame 30, the generation of a gap between a face 91b of the user 90 and the mask main body 21 can be suppressed. FIG. 3 is an example of a top view of the mask 10 illustrated in FIG. 1. For example, as illustrated in FIG. 3, the mask 10 may include a filler 81 that fills the gap generated between the mask portion 20 and the mask frame 30. The filler disposed between the mask portion 20 and the mask frame 30 may be made of a cushioning material such as polyurethane. The filler disposed between the mask portion 20 and the mask frame 30 can be fixed to at least one of the mask portion 20 and the mask frame 30, for example, by an adhesive. Here, as the adhesive, for example, a double-sided tape in which adhesive layers are formed on both surfaces of the tape may be adopted.

The mask 10 can include a filler that fills the gap generated between the face 91b of the user 90 and the mask main body 21. The filler disposed between the face 91b and the mask main body 21 may be made of a cushioning material such as polyurethane. The filler disposed between the face 91b and the mask main body 21 can be fixed to at least one of the face 91b and the mask main body 21 by, for example, an adhesive. Here, as the adhesive, for example, a double-sided tape in which adhesive layers are formed on both surfaces of the tape may be adopted.

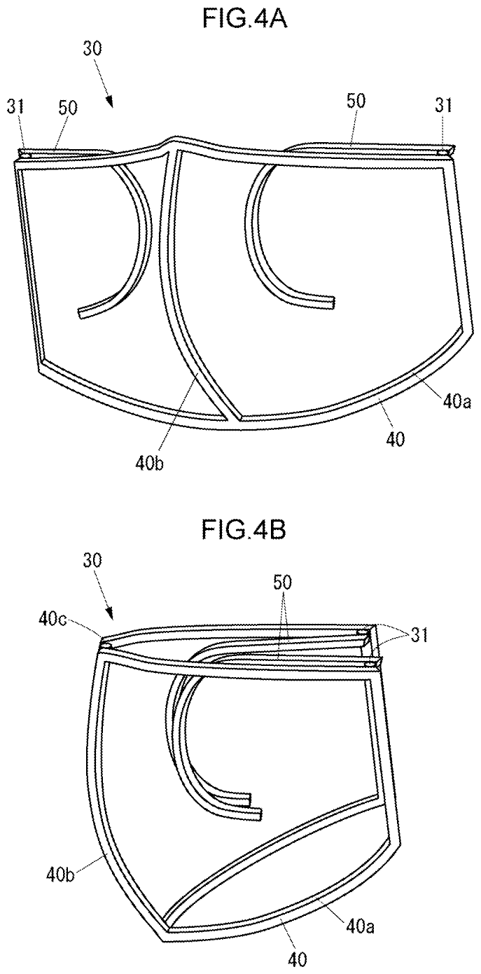

FIG. 4A is an example of a perspective view of the mask frame 30 in a state of being bent at a specific location. FIG. 4B is a perspective view of the mask frame 30 in a state of being bent at a specific location, which is an example different from the example illustrated in FIG. 4A.

The mask frame 30 may be bendable at a specific location. For example, the mask frame 30 may be bendable at the location of a hinge 31 by providing the hinge 31 between the frame main body 40 and the attachment portion 50 as illustrated in FIG. 4A, or may be bendable at the location of a hinge 40c by further providing the hinge 40c at the central portion in the horizontal direction of the frame main body 40 as illustrated in FIG. 4B. When the mask frame 30 is bendable at a specific location, the mask frame 30 can be bent at the specific location to be downsized, thereby improving the portability.

In the example shown in FIGS. 4A and 4B, the frame main body 40 and the attachment portion 50 are separate components, and thus are connected by the hinge 31. However, the frame main body 40 and the attachment portion 50 may be integrally formed as one component.

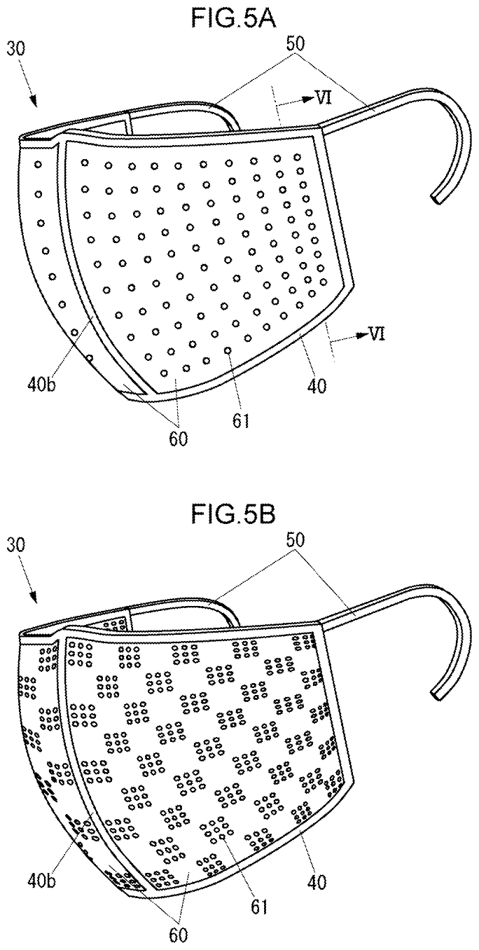

FIG. 5A is an example of a perspective view of the mask frame 30 in a state where a cover 60 is attached. FIG. 5B is a perspective view of the mask frame 30 in a state where the cover 60 is attached, which is an example different from the example illustrated in FIG. 5A.

As illustrated in FIGS. 5A and 5B, the mask frame 30 may include the cover 60 that covers at least a part of the mask main body 21 (see FIG. 2) of the mask portion 20 (see FIG. 2).

The cover 60 is detachably attached to the frame main body 40. The cover 60 can be formed of various materials such as plastic having high flexibility, plastic having low flexibility, and metal.

A large number of vent holes 61 are formed in the cover 60. As the shape and size of the hole 61, various shapes and sizes, for example, a circle having a diameter of 1 mm can be adopted. The large number of holes 61 can be disposed at any position on the cover 60. For example, the large number of holes 61 may be disposed substantially uniformly apart from each other in the entire cover 60 as illustrated in FIG. 5A, or may be disposed in a part of the cover 60 as illustrated in FIG. 5B to form an optional pattern as the entire group of the large number of holes 61.

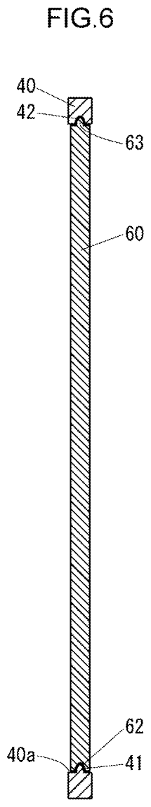

As illustrated in FIG. 6, the cover 60 may be attached to the frame main body 40 by fitting a convex portion into a concave portion.

FIG. 6 is an example of an end view taken along line VI-VI in FIG. 5A.

In the cover 60 illustrated in FIG. 6, a convex portion 41 formed in the frame main body 40 is fitted into a concave portion 62 formed in the cover 60, and a convex portion 63 formed in the cover 60 is fitted into a concave portion 42 formed in the frame main body 40. When the convex portion is fitted into the concave portion to attach the cover 60 to the frame main body 40, or when the convex portion and the concave portion are disengaged to remove the cover 60 from the frame main body 40, at least one of the frame main body 40 and the cover 60 can be temporarily elastically deformed.

In the example illustrated in FIG. 6, the concave portion 62 is formed at the lower end of the cover 60, and the convex portion 63 is formed at the upper end of the cover 60. However, the formation of any of the convex portion and the concave portion in any of the frame main body 40 and the cover 60 at any position where the frame main body 40 and the cover 60 are adjacent to each other depends on the design.

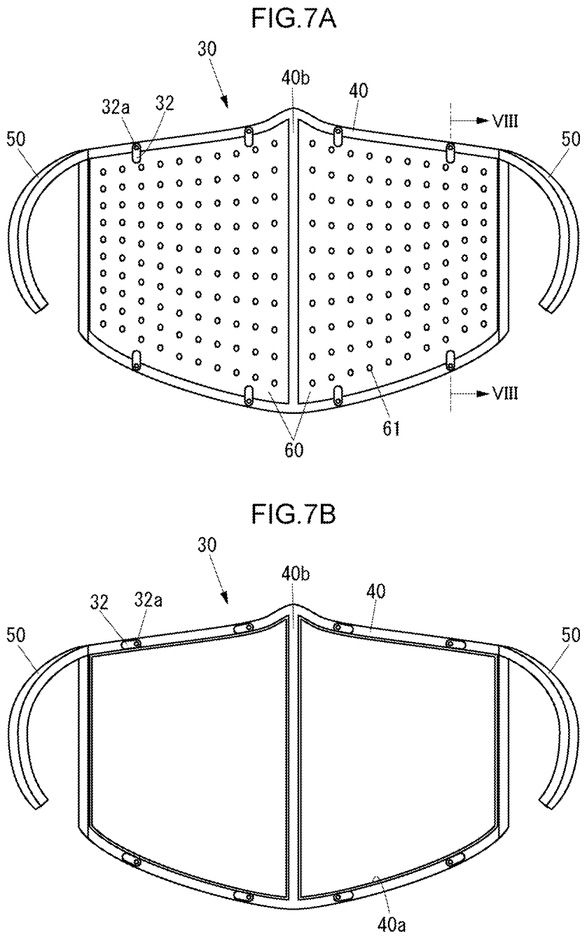

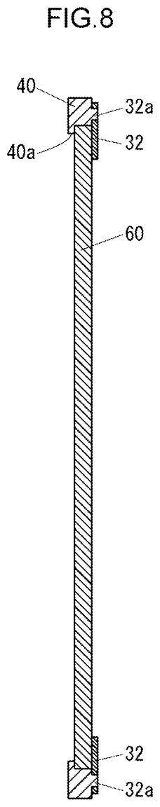

As illustrated in FIGS. 7A to 8, the cover 60 may be attached to the frame main body 40 with a fastener.

FIG. 7A is an example of a rear view of the mask frame 30 in a state where the cover 60 is attached to the frame main body 40 with a fastener 32. FIG. 7B is a rear view of the mask frame 30 illustrated in FIG. 7A in a state where the cover 60 is not attached to the frame main body 40. FIG. 8 is an end view taken along line VIII-VIII in FIG. 7A.

As illustrated in FIGS. 7A to 8, the mask frame 30 includes a plurality of fasteners 32 for fixing the cover 60 to the frame main body 40. The fastener 32 is attached to the frame main body 40 so as to be rotatable about a shaft 32a.

In the example shown in FIGS. 7A to 8, the cover 60 is fixed to the frame main body 40 by the two upper and two lower fasteners 32. However, the provision of any number of fasteners at any position with respect to the cover 60 depends on the design.

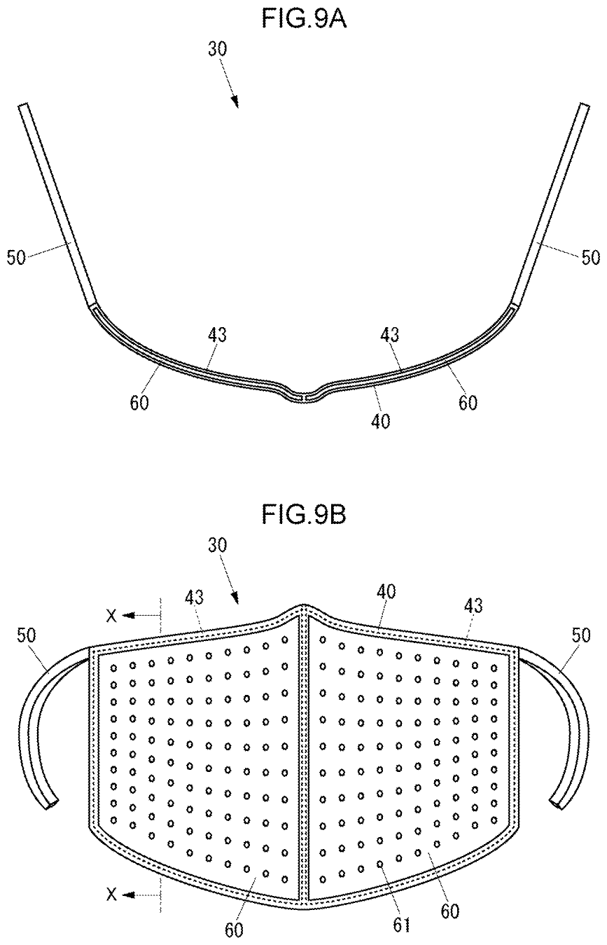

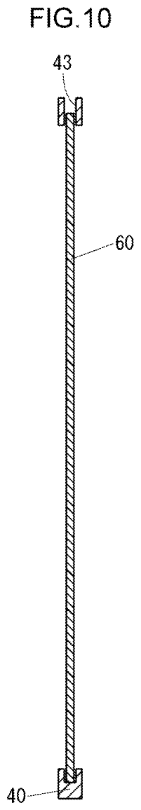

As illustrated in FIGS. 9A to 10, the cover 60 may be attached to the frame main body 40 by being inserted into a groove 43 formed in the frame main body 40.

FIG. 9A is an example of a plan view of the mask frame 30 in a state where the cover 60 is inserted into the groove 43 formed in the frame main body 40. FIG. 9B is a front view of the mask frame 30 illustrated in FIG. 9A. FIG. 10 is an end view taken along line X-X in FIG. 9B.

The cover 60 illustrated in FIGS. 9A to 10 is attached to the frame main body 40 by being inserted into the groove 43 formed in the frame main body 40 from above.

As a method of attaching the cover 60 to the frame main body 40, various methods other than the above-described method can be adopted.

In the examples illustrated in FIGS. 5A to 10, the cover 60 is disposed at a position to cover the entire hole 40a of the frame main body 40 at a portion other than the vent hole 61. However, the cover 60 may be disposed at a position other than the positions illustrated in FIGS. 5A to 10 with respect to the frame main body 40.

In the examples illustrated in FIGS. 5A to 10, the cover 60 is detachably attached to the frame main body 40. However, the frame main body 40 may be a component in which a cover that covers at least a part of the mask main body 21 of the mask portion 20 is integrally formed.

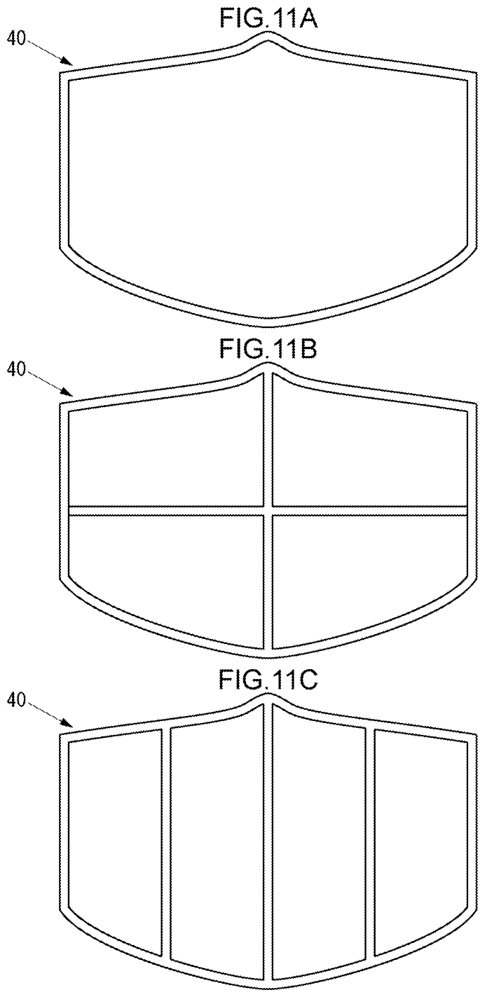

FIG. 11A is a front view of the frame main body 40, which is an example different from the example illustrated in FIG. 1. FIG. 11B is a front view of the frame main body 40, which is an example different from the examples illustrated in FIGS. 1 and 11A. FIG. 11C is a front view of the frame main body 40, which is an example different from the examples illustrated in FIGS. 1, 11A, and 11B.

In the example illustrated in FIG. 1, the frame main body 40 includes the vertical extending portion 40b at the center in the horizontal direction. However, the manufacturer of the mask frame 30 can also adopt a shape other than the shape illustrated in FIG. 1 as the shape of the frame main body 40 in consideration of, for example, strength, design, and the like. For example, the shape of the frame main body 40 may be the shape shown in any one of FIGS. 11A to 11C.

The mask frame 30 may include a string fixing portion that fixes the string 22 of the mask portion 20 to the attachment portion 50.

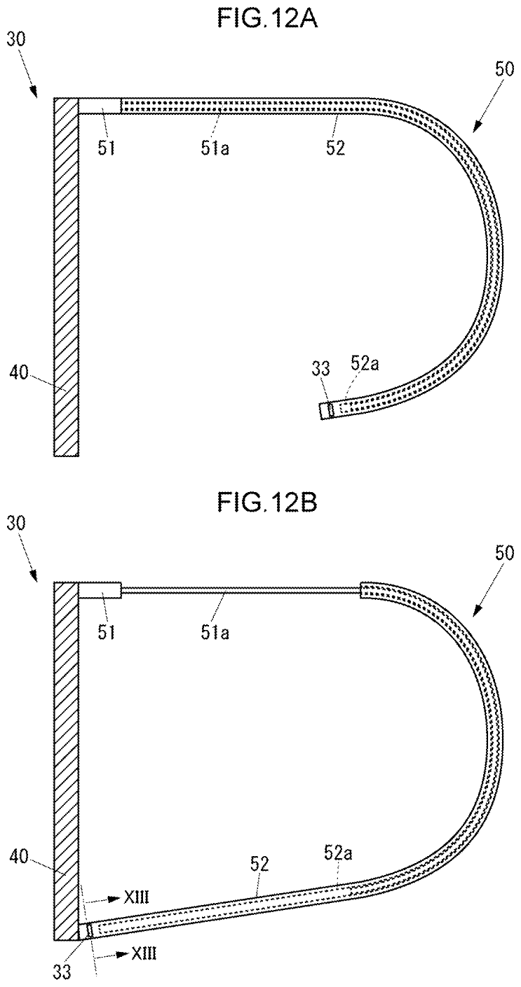

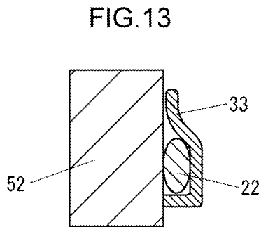

As illustrated in FIGS. 12A to 13, the string fixing portion may be configured by, for example, a clip 33.

FIG. 12A is an example of a side cross-sectional view of the mask frame 30 in a state where the attachment portion 50 is contracted. FIG. 12B is a side cross-sectional view of the mask frame 30 illustrated in FIG. 12A in a state where the attachment portion 50 is elongated. FIG. 13 is an end view taken along line XIII-XIII in FIG. 12B in a state where the string 22 is fixed to the attachment portion 50 by the clip 33.

The attachment portion 50 illustrated in FIGS. 12A to 13 includes a portion 51 attached to the frame main body 40 and a portion 52 attached to the portion 51. The mask frame 30 illustrated in FIGS. 12A to 13 includes the clip 33 for fixing the string 22 of the mask portion 20 (see FIG. 1). The portion 51 includes an insertion portion 51a inserted into the portion 52. The portion 52 has a hole 52a into which the insertion portion 51a is inserted. The portion 52 is made of a highly flexible material such as rubber. The clip 33 is fixed to the portion 52. The attachment portion 50 can be elongated and contracted between a contracted state as illustrated in FIG. 12A and an elongated state as illustrated in FIG. 12B by adjusting the insertion amount of the insertion portion 51a of the portion 51 into the hole 52a of the portion 52.

Since the mask frame 30 illustrated in FIGS. 12A to 13 includes the clip 33 in the portion 52, the string 22 of the mask portion 20 can be fixed to the portion 52 by the clip 33. Therefore, the mask frame 30 illustrated in FIGS. 12A to 13 can facilitate the covering of at least a part of the string 22 of the mask portion 20 with the attachment portion 50.

The attachment portion 50 may be elongated and contracted by a structure other than the structure illustrated in FIGS. 12A and 12B. The attachment portion 50 may include the clip for fixing the string 22 of the mask portion 20 at a position other than the position illustrated in FIGS. 12A and 12B.

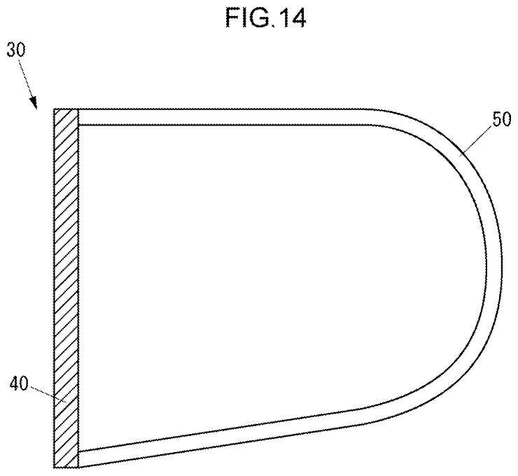

FIG. 14 is an example of a side cross-sectional view of the mask frame 30 when the attachment portion 50 has an annular shape.

The attachment portion 50 may have the annular shape as illustrated in FIG. 14. The attachment portion 50 illustrated in FIG. 14 may be detachably attached to the frame main body 40. In the mask frame 30, when the attachment portion 50 is detachably attached to the frame main body 40, the attachment portion 50 having a shape and size corresponding to the shape and size of the head 91 of the user 90 can be attached to the frame main body 40.

The mask frame 30 illustrated in FIG. 14 may include a string fixing portion such as a clip for fixing the string 22 of the mask portion 20 to the attachment portion 50 at any position on the attachment portion 50.

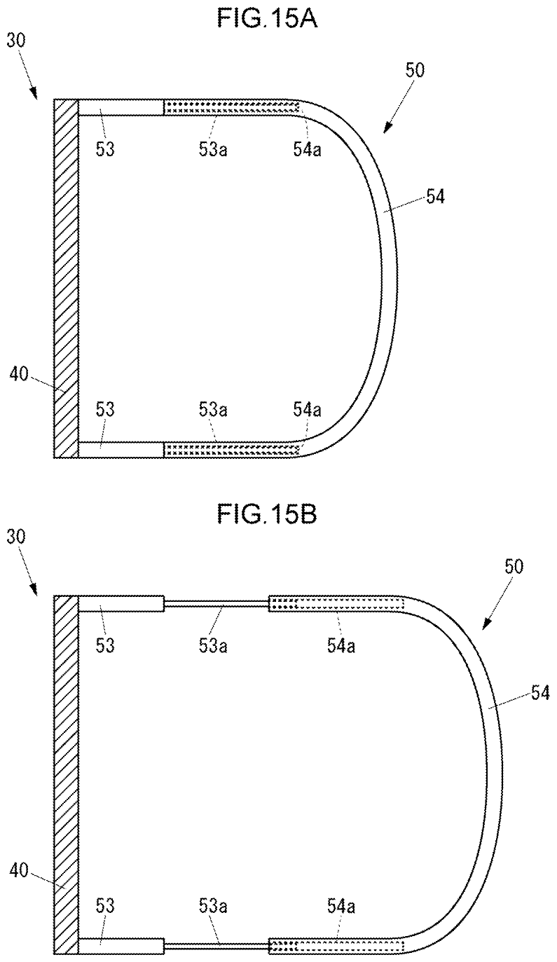

FIG. 15A is an example of a side cross-sectional view of the mask frame 30 in a state where the attachment portion 50 is contracted when the attachment portion 50 has an annular shape. FIG. 15B is a side cross-sectional view of the mask frame 30 illustrated in FIG. 15A in a state where the attachment portion 50 is elongated.

The attachment portion 50 illustrated in FIGS. 15A and 15B includes a portion 53 attached to the frame main body 40 and a portion 54 attached to the portion 53. The portion 53 includes an insertion portion 53a inserted into the portion 54. The portion 54 has a hole 54a into which the insertion portion 53a is inserted. The attachment portion 50 can be elongated and contracted between a contracted state as illustrated in FIG. 15A and an elongated state as illustrated in FIG. 15B by adjusting the insertion amount of the insertion portion 53a of the portion 53 into the hole 54a of the portion 54. When the attachment portion 50 can be elongated and contracted, the mask frame 30 can be adjusted such that the length of attachment portion 50 matches the shape and size of the head 91 of the user 90. The attachment portion 50 may be elongated and contracted by a structure other than the structure illustrated in FIGS. 15A and 15B.

The mask frame 30 illustrated in FIGS. 15A and 15B may include a string fixing portion such as a clip for fixing the string 22 of the mask portion 20 to the attachment portion 50 at any position on the attachment portion 50.

As described above, in the mask frame 30, the frame main body 40 covers at least a part of the end portion 21a of the mask main body 21, whereby at least a part of the contour of the mask 10, which greatly affects the aesthetic properties of the mask 10, can be configured by the mask frame 30. Therefore, in the mask frame 30, the aesthetic properties of the mask 10 can be improved by the design of the mask frame 30.

When the mask frame 30 includes the cover 60 as illustrated in FIGS. 5A to 10, the cover 60 covers at least a part of the mask main body 21, whereby the aesthetic properties of the mask 10 can be improved by the design of the cover 60.

When the mask frame 30 includes the string fixing portion such as the clip 33 illustrated in FIGS. 12A to 13, the string 22 is fixed to the attachment portion 50 by the string fixing portion, whereby the possibility that the string 22 is separated from the attachment portion 50 and stands out can be reduced. Therefore, the mask frame 30 can improve the aesthetic properties of the mask 10.

Various designs of the mask frame 30 can be realized by the pattern, color, and material of the frame main body 40, the attachment portion 50, or the cover 60. For example, in the mask frame 30, when the frame main body 40, the attachment portion 50, and the cover 60 are formed of metal, a formal feeling can be provided as the entire mask 10. In the mask frame 30, when the frame main body 40, the attachment portion 50, and the cover 60 are formed of plastic having a pop color, a casual feeling can be provided as the entire mask 10.

When the mask frame 30 includes the cover 60 as illustrated in FIGS. 5A to 10 so as to be detachably attached to the frame main body 40, the cover 60 is detachably attached to the frame main body 40, whereby the design of the mask 10 can be easily changed by replacing the cover 60.

The mask portion 20 used in combination with the mask frame 30 is replaceable, whereby the mask frame 30 can be used for a long period by replacing the mask portion 20.

### Second Embodiment

The configuration of a mask according to a second embodiment of the present invention is similar to the configuration of the mask 10 according to the first embodiment except for the description made below. In the configuration of the mask according to the present embodiment, portions similar to those of the mask 10 are denoted by the same reference numerals as those of the mask 10, and a detailed description thereof will be omitted.

A mask frame of the mask according to the present embodiment includes a mask main body fixing portion that fixes a mask main body to a frame main body.

The mask main body fixing portion may be made of an adhesive. For example, the mask main body fixing portion may be formed of a double-sided tape in which adhesive layers are formed on both surfaces of the tape. The mask main body fixing portion may be formed of an adhesive layer provided in advance on the mask main body. The position of the mask main body fixing portion formed of the adhesive with respect to the mask main body depends on the design.

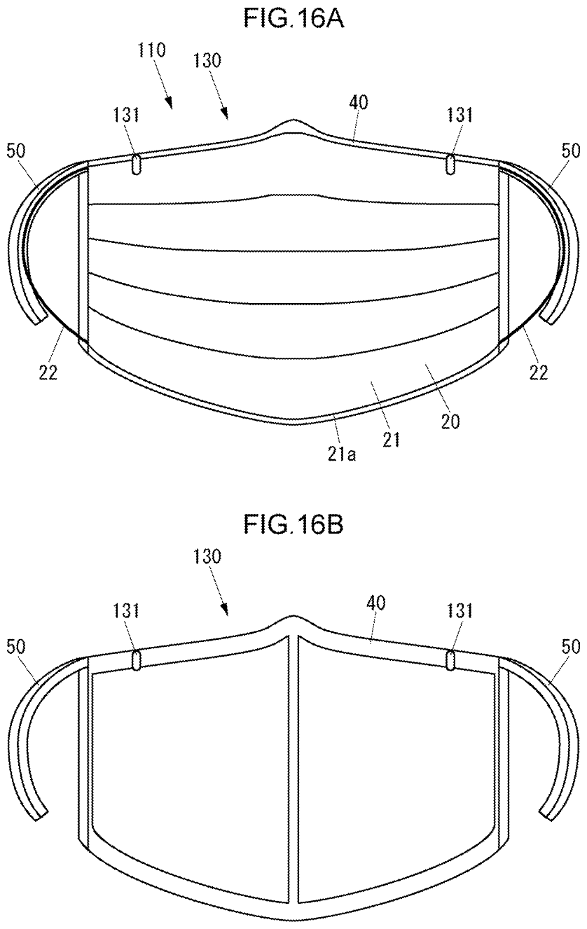

As illustrated in FIGS. 16A and 16B, the mask main body fixing portion may be configured by, for example, a clip 131.

FIG. 16A is an example of a rear view of a mask 110 according to the present embodiment. FIG. 16B is an example of a rear view of a mask frame 130 illustrated in FIG. 16A.

As illustrated in FIGS. 16A and 16B, the mask frame 130 includes the clip 131 that fixes a mask main body 21 of a mask portion 20 to a frame main body 40.

In the example illustrated in FIGS. 16A and 16B, the clip 131 is provided on each of the left and right sides of the upper portion of the frame main body 40. However, the provision of any number of the clips 131 at any position with respect to the frame main body 40 depends on the design.

The mask main body fixing portion can be realized by various configurations other than the above-described configuration.

The mask 110 can include the filler that fills the gap generated between the face 91b (see FIG. 1) of the user 90 (see FIG. 1) and the mask main body 21. The filler disposed between the face 91b and the mask main body 21 may be made of a cushioning material such as polyurethane. The filler disposed between the face 91b and the mask main body 21 can be fixed to at least one of the face 91b and the mask main body 21 by, for example, an adhesive. Here, as the adhesive, for example, a double-sided tape in which adhesive layers are formed on both surfaces of the tape may be adopted.

As described above, in the mask frame 130, the mask main body 21 of the mask portion 20 is fixed to the frame main body 40 by the mask main body fixing portion, whereby the possibility that at least a part of an end portion 21a of the mask main body 21 of the mask portion 20 protrudes from the frame main body 40 and is exposed when the mask frame 130 is attached to the head 91 (see FIG. 1) of the user 90 can be reduced. Therefore, the mask frame 130 can improve the aesthetic properties of the mask 110.

### Third Embodiment

The configuration of a mask according to a third embodiment of the present invention is similar to the configuration of the mask 10 according to the first embodiment except for the description made below. In the configuration of the mask according to the present embodiment, portions similar to those of the mask 10 are denoted by the same reference numerals as those of the mask 10, and a detailed description thereof will be omitted.

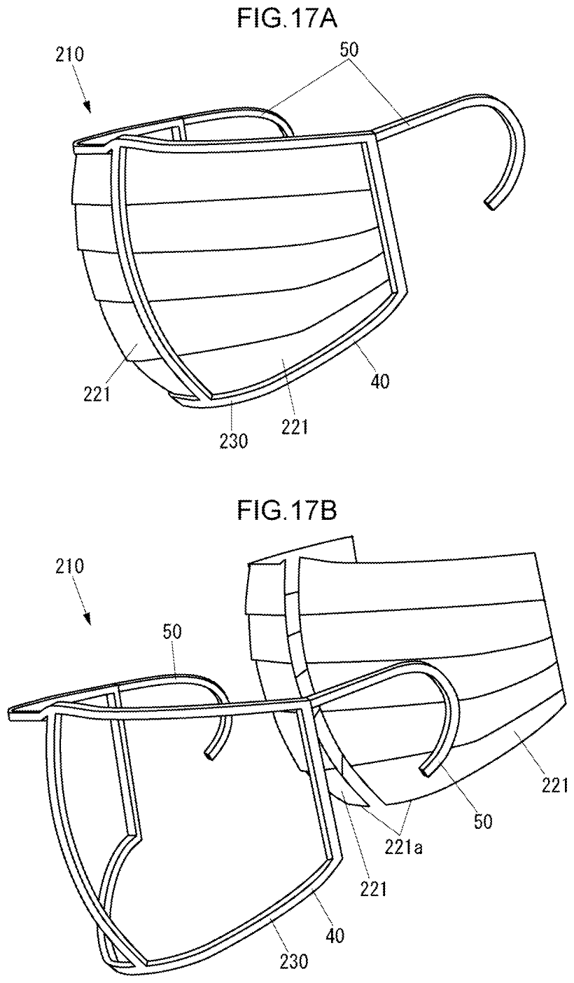

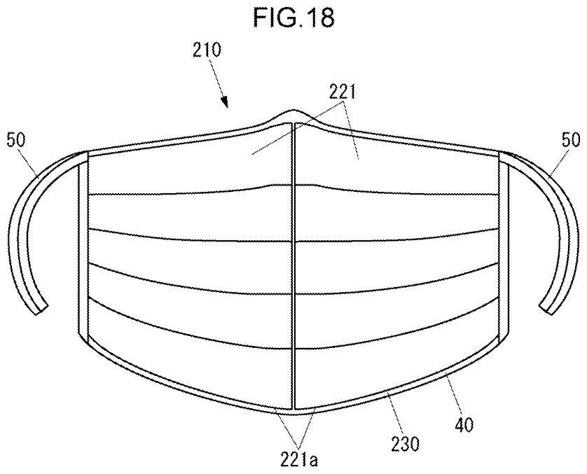

FIG. 17A is an example of a perspective view of a mask 210 according to the present embodiment. FIG. 17B is an exploded perspective view of the mask 210 illustrated in FIG. 17A. FIG. 18 is an example of a rear view of the mask 210 illustrated in FIG. 17A.

As illustrated in FIGS. 17A to 18, the mask 210 includes a mask main body 221 and a mask frame 230 that covers at least a part of the mask main body 221.

The mask main body 221 can be formed of various materials such as a cloth other than a nonwoven fabric (such as a cotton woven fabric), a nonwoven fabric, and polyurethane. Unlike the mask main body 21 (see FIG. 2) according to the first embodiment, the mask main body 221 is not connected with a string to be hooked to the ear 91a (see FIG. 2) of the user 90 (see FIG. 2).

The mask 210 includes a mask main body fixing portion that fixes the mask main body 221 to the frame main body 40 of the mask frame 230.

The mask main body fixing portion may be made of an adhesive. For example, the mask main body fixing portion may be formed of a double-sided tape in which adhesive layers are formed on both surfaces of the tape. The mask main body fixing portion may be formed of an adhesive layer provided in advance on the mask main body 221. The position of the mask main body fixing portion formed of the adhesive with respect to the mask main body 221 depends on the design. For example, the mask main body fixing portion formed of the adhesive may be disposed at each of four corners of the mask main body 221.

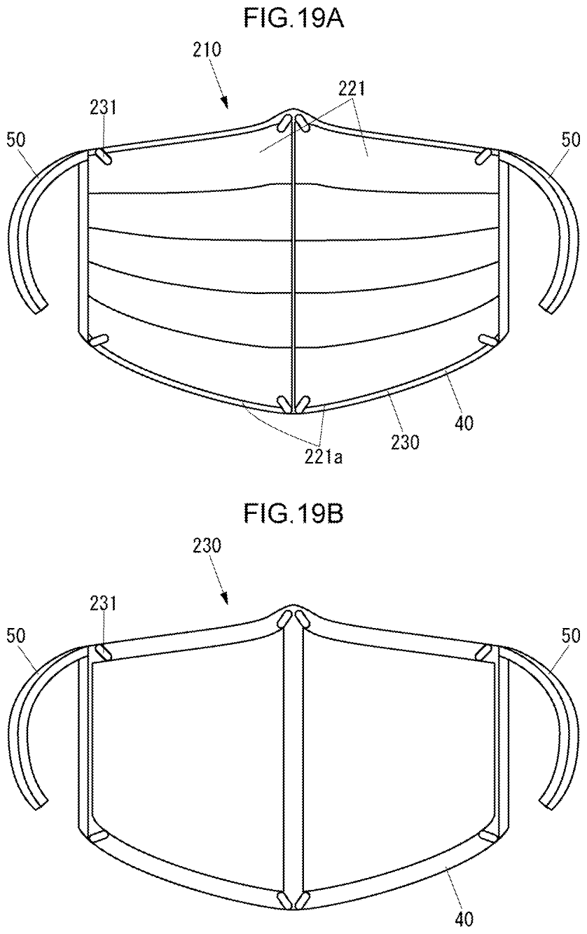

As illustrated in FIGS. 19A and 19B, the mask main body fixing portion may be configured by, for example, a clip 231.

FIG. 19A is an example of a rear view of the mask 210 in a state where the mask main body 221 is fixed to the frame main body 40 by the clip 231. FIG. 19B is a rear view of the mask frame 230 illustrated in FIG. 19A.

As illustrated in FIGS. 19A and 19B, the mask frame 230 includes the clip 231 that fixes the mask main body 221 to the frame main body 40 on the frame main body 40.

In the example illustrated in FIGS. 19A and 19B, the clip 231 is provided at each of positions where four corners of the mask main body 221 are fixed. However, the provision of any number of the clips 231 at any position with respect to the frame main body 40 depends on the design.

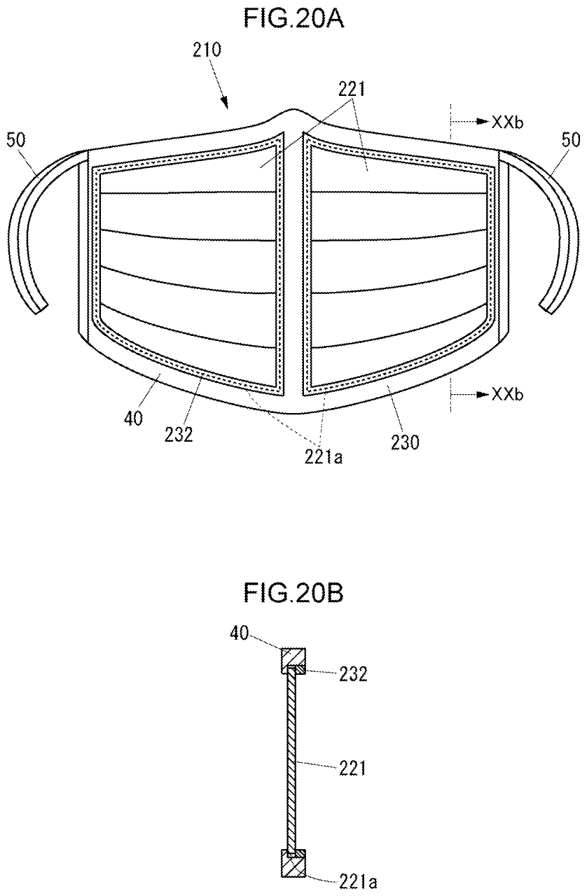

As illustrated in FIGS. 20A and 20B, the mask main body fixing portion may be configured by a pressing member 232 that presses and fixes the mask main body 221 to the frame main body 40.

FIG. 20A is an example of a rear view of the mask 210 in a state where the mask main body 221 is fixed to the frame main body 40 by the pressing member 232. FIG. 20B is an end view taken along line XXb-XXb in FIG. 20A.

The mask frame 230 illustrated in FIGS. 20A and 20B includes the pressing member 232 that presses and fixes the mask main body 221 to the frame main body 40.

The pressing member 232 is detachably attached to the frame main body 40. As a method in which the pressing member 232 is fixed to the frame main body 40, for example, various methods can be adopted, such as a method in which a pin (not shown) provided on one of the frame main body 40 and the pressing member 232 is press-fitted into a hole (not shown) provided on the other of the frame main body 40 and the pressing member 232 to fix the pressing member 232 to the frame main body 40 by frictional force between an outer wall surface of the pin and a wall surface forming the hole.

The mask main body fixing portion can be realized by various configurations other than the above-described configuration.

The mask 210 can include a filler that fills a gap generated between the face 91b (see FIG. 1) of the user 90 (see FIG. 1) and the mask main body 221. The filler disposed between the face 91b and the mask main body 221 may be made of a cushioning material such as polyurethane. The filler disposed between the face 91b and the mask main body 221 can be fixed to at least one of the face 91b and the mask main body 221 by, for example, an adhesive. Here, as the adhesive, for example, a double-sided tape in which adhesive layers are formed on both surfaces of the tape may be adopted.

As described above, in the mask 210, the mask main body 221 is fixed to the frame main body 40 by the mask main body fixing portion, whereby the possibility that at least a part of the end portion 221a of the mask main body 221 protrudes from the frame main body 40 and is exposed when the mask frame 230 is attached to the head 91 (see FIG. 1) of the user 90 can be reduced. Therefore, the aesthetic properties of the mask 210 can be improved.

In the mask 210, the string hooked to the ear 91a (see FIG. 1) of the user 90 is not connected to the mask main body 221, whereby the string is not exposed when the mask frame 230 is attached to the head 91 of the user 90. Therefore, the aesthetic properties of the mask 210 can be improved.

What is claimed is:

1. A mask frame for use in combination with a replaceable mask main body, comprising:
a frame main body that covers at least a part of an end portion of the mask main body;
an attachment portion that is attached to a head of a user to hold the frame main body at a specific position with respect to the head; and
a cover that is disposed at a specific position with respect to the frame main body to cover at least a part of the mask main body.

2. The mask frame according to claim 1, wherein the cover is detachably attached to the frame main body.

3. The mask frame according to claim 2, wherein the cover is detachably attached to the frame main body separately from the mask main body.

4. The mask frame according to claim 1, wherein a main material of the cover is different from a main material of the mask main body.

5. The mask frame according to claim 1, wherein a main material of the cover is plastic or metal.

6. The mask frame according to claim 1, wherein a vent hole is formed in the cover.

7. The mask frame according to claim 6, wherein the cover has a pattern formed by a plurality of the holes.

8. The mask frame according to claim 1, wherein the cover is attached to the frame main body by fitting a convex portion formed on one of the cover and the frame main body into a concave portion formed on the other of the cover and the frame main body.

9. The mask frame according to claim 1,
further comprising a fastener that fixes the cover to the frame main body,
wherein the cover is attached to the frame main body with the fastener.

10. The mask frame according to claim 1, wherein the cover is attached to the frame main body by being inserted into a groove formed in the frame main body.

11. The mask frame according to claim 1, further comprising a string fixing portion that fixes, to the attachment portion, a string that is attached to the head to hold the mask main body at a specific position with respect to the head.

12. The mask frame according to claim 11, wherein the string fixing portion fixes the string to the attachment portion in a state where at least a part of the string is covered by the attachment portion when the attachment portion is attached to the head.

13. The mask frame according to claim 1, further comprising a mask main body fixing portion that fixes the mask main body to the frame main body.

14. A mask comprising:
the mask frame according to claim 13; and
the mask main body.

15. A mask comprising:
the mask frame according to claim 1;
the mask main body; and
a filler that fills a gap generated between the mask frame and the mask main body.
